(19) United States
(12) Patent Application Publication
(10) Pub. No.: US 2024/0236142 A1
(43) Pub. Date: Jul. 11, 2024

(54) SECURITY THREAT ANALYSIS

(71) Applicant: VMware, Inc., Palo Alto, CA (US)

(72) Inventors: Stijn VANVEERDEGHEM, Topanga, CA (US); Abha MUTALIK, Mountain View, CA (US); Robin MANHAS, Cupertino, CA (US); Geoff SHUKIN, Calgary (CA); Nikhil SANGVIKAR, Mountain View, CA (US); Priya JOSHI, San Jose, CA (US)

(73) Assignee: VMware, Inc., Palo Alto, CA (US)

(21) Appl. No.: 18/095,536

(22) Filed: Jan. 11, 2023

(51) Int. Cl. H04L 9/40

(52) U.S. Cl. CPC H04L 63/1441; H04L 63/0263; H04L 63/1416

(57) ABSTRACT

Example methods and systems for security threat analysis are described. One example may involve a first computer system configuring a test packet that includes malicious content for forwarding along a network path between (a) a first network element that is connected with a first virtualized computing instance and (b) a second network element that is connected with a second virtualized computing instance. The test packet may be injected at the first network element and forwarded towards the second network element. In response to a security checkpoint detecting the test packet, the security checkpoint may apply one or more security policies on the test packet; and generate and send report information towards a management entity. The report information may indicate whether the malicious content in the test packet is detectable based on the one or more security policies.

### BACKGROUND

Virtualization allows the abstraction and pooling of hardware resources to support virtual machines in a software-defined data center (SDDC). For example, through server virtualization, virtualized computing instances such as virtual machines

(VMs) running different operating systems may be supported by the same physical machine (e.g., host). Each VM is generally provisioned with virtual resources to run a guest operating system and applications. The virtual resources may include central processing unit (CPU) resources, memory resources, storage resources, network resources, etc. In practice, it is desirable to detect potential security threats that may affect the performance of hosts and VMs in the SDDC.

### BRIEF DESCRIPTION OF DRAWINGS

FIG. 1 is a schematic diagram illustrating an example software-defined networking (SDN) environment in which security threat analysis may be implemented;

FIG. 2 is a schematic diagram illustrating an example physical view of hosts in an SDN environment;

FIG. 3 is a flowchart of an example process for a first computer system to perform security threat analysis;

FIG. 4 is a flowchart of an example detailed process for a first computer system to perform security threat analysis;

FIG. 5 is a schematic diagram illustrating an example user interface for initiating a security threat analysis in an SDN environment;

FIG. 6 is a schematic diagram illustrating a detailed example of security threat analysis in an SDN environment;

FIG. 7 is a schematic diagram illustrating an example user interface for presenting report information associated with security threat analysis in an SDN environment;

FIG. 8 is a diagram illustrating example report information associated with an intrusion detection and prevention system (IDPS) event during security threat analysis; and

FIG. 9 is a schematic diagram illustrating an example security threat analysis for an end-to-end attack scenario in an SDN environment.

### DETAILED DESCRIPTION

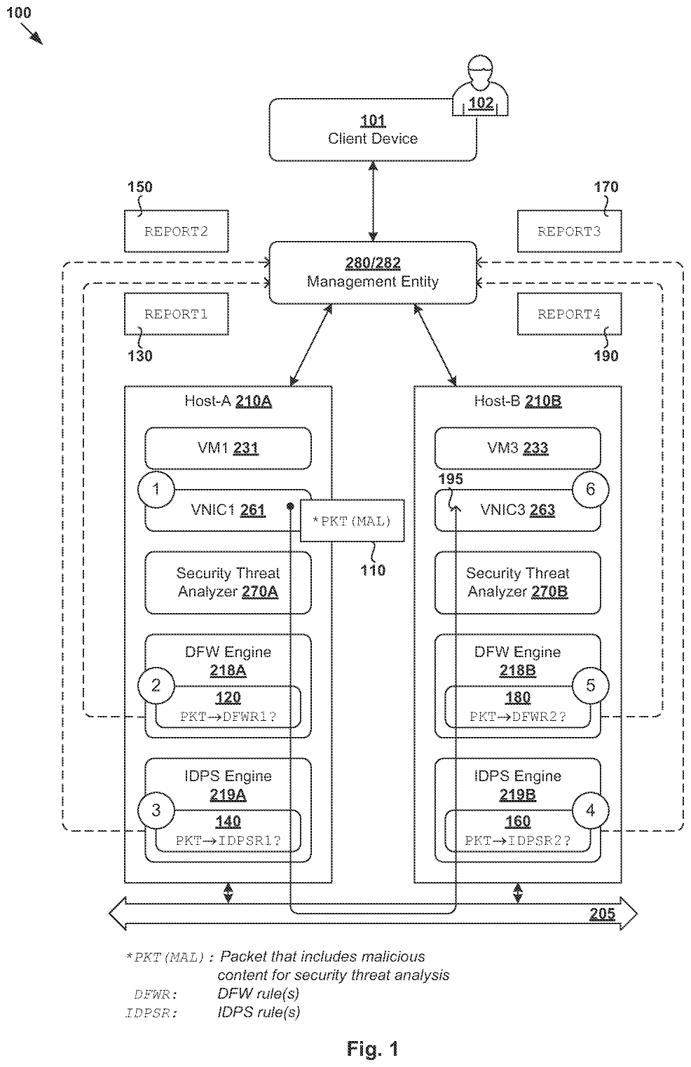

According to examples of the present disclosure, security threat analysis may be implemented to improve data center security. One example may involve a first computer system (e.g., host 210A in FIG. 1) configuring a test packet (see 110 in FIG. 1) that includes malicious content for forwarding along a network path between (a) a first network element (e.g., VNIC1 261) that is connected with a first virtualized computing instance supported by the first computer system (e.g., VM1 231 on host-A 210A) and (b) a second network element (e.g., VNIC3 263) that is connected with a second virtualized computing instance supported by the first computer system or a second computer system (e.g., VM3 233 on host-B 210B).

Next, the test packet may be injected at the first network element and forwarded towards the second network element. The test packet may be detected by a security checkpoint (e.g., 218A/219A in FIG. 1) that is located along the network path and supported by the first computer system. In response to detecting the test packet, the security checkpoint may apply one or more security policies on the test packet; and generate and send report information towards a management entity (e.g., 280/282 in FIG. 1). The report information may indicate whether the malicious content in the test packet is detectable based on the one or more security policies. In practice, examples of the present disclosure may be implemented to test the effectiveness of security policies as a form of security controls against any suitable security threat(s). Various examples will be described using FIGS. 1-9.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein.

Although the terms “first” and “second” are used to describe various elements, these elements should not be limited by these terms. These terms are used to distinguish one element from another. For example, a first element may be referred to as a second element, and vice versa.

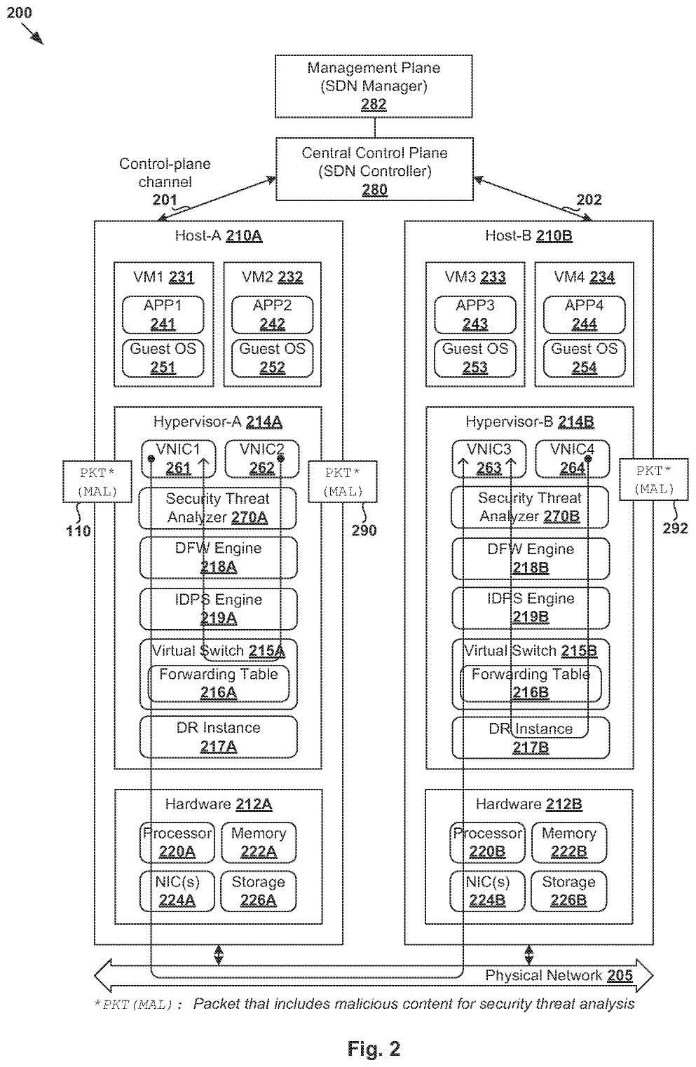

FIG. 1 is a schematic diagram illustrating example software-defined networking (SDN) environment 100 in which security threat analysis may be performed. FIG. 2 is a schematic diagram illustrating example physical view 200 of hosts in SDN environment 100. It should be understood that, depending on the desired implementation, SDN environment 100 may include additional and/or alternative components than that shown in FIG. 1 and FIG. 2. In practice, SDN environment 100 may include any number of hosts (also known as “computer systems,” “computing devices”, “host computers”, “host devices”, “physical servers”, “server systems”, “transport nodes,” etc.).

In the example in FIG. 1, SDN environment 100 may include management entity 280/282, and hosts 210A-B that are connected via physical network 205.

Referring also to FIG. 2, host 210A/210B may include suitable hardware 212A/212B and virtualization software (e.g., hypervisor 214A/214B) to support various VMs 231-234.

For example, host-A 210A may support VM1 231 and VM2 232, while VM3 233 and VM4 234 are supported by host-B 210B. Hardware 212A/212B includes suitable physical components, such as central processing unit(s) (CPU(s)) or processor(s) 220A/220B; memory 222A/222B; physical network interface controllers (PNICs) 224A/224B; and storage disk(s) 226A/226B, etc.

Hypervisor 214A/214B maintains a mapping between underlying hardware 212A/212B and virtual resources allocated to respective VMs. Virtual resources are allocated to respective VMs 231-234 to support a guest operating system (OS; not shown for simplicity) and application(s); see 241-244, 251-254. For example, the virtual resources may include virtual CPU, guest physical memory, virtual disk, virtual network interface controller (VNIC), etc. Hardware resources may be emulated using virtual machine monitors (VMMs). For example in FIG. 2, VNICs 261-264 are virtual network adapters for VMs 231-234, respectively, and are emulated by corresponding VMMs (not shown) instantiated by their respective hypervisor at respective host-A 210A and host-B 210B. The VMMs may be considered as part of respective VMs, or alternatively, separated from the VMs. Although one-to-one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc.

Such container technology is available from, among others, Docker, Inc. The VMs may also be complete computational environments, containing virtual equivalents of the hardware and software components of a physical computing system.

The term “hypervisor” mayrefer generally to a software layer or component that supports the execution of multiple virtualized computing instances, including system-level software in guest VMs that supports namespace containers such as Docker, etc. Hypervisors 214A-B may each implement any suitable virtualization technology, such as VMware ESX® or ESXi™ (available from VMware, Inc.), Kernel-based Virtual Machine (KVM), etc. The term “packet” mayrefer generally to a group of bits that can be transported together, and may be in another form, such as “frame,” “message,” “segment,” etc. The term “traffic” or “flow” mayrefer generally to multiple packets. The term “layer-2” mayrefer generally to a link layer or media access control (MAC) layer; “layer-3” a network or Internet Protocol (IP) layer; and “layer-4” a transport layer (e.g., using Transmission Control Protocol (TCP), User Datagram Protocol (UDP), etc.), in the Open System Interconnection (OSI) model, although the concepts described herein may be used with other networking models.

SDN controller 280 and SDN manager 282 are example network management entities in SDN environment 100. One example of an SDN controller is the NSX controller component of VMware NSX® (available from VMware, Inc.) that operates on a central control plane. SDN controller 280 may be a member of a controller cluster (not shown for simplicity) that is configurable using SDN manager 282. Network management entity 280/282 may be implemented using physical machine(s), VM(s), or both. To send or receive control information, a local control plane (LCP) agent (not shown) on host 210A/210B may interact with SDN controller 280 via control-plane channel 201/202.

Through virtualization of networking services in SDN environment 100, logical networks (also referred to as overlay networks or logical overlay networks) may be provisioned, changed, stored, deleted and restored programmatically without having to reconfigure the underlying physical hardware architecture. Hypervisor 214A/214B implements virtual switch 215A/215B and logical distributed router (DR) instance 217A/217B to handle egress packets from, and ingress packets to, VMs 231-234. In SDN environment 100, logical switches and logical DRs may be implemented in a distributed manner and can span multiple hosts.

For example, a logical switch (LS) may be deployed to provide logical layer-2 connectivity (i.e., an overlay network) to VMs 231-234. A logical switch may be implemented collectively by virtual switches 215A-B and represented internally using forwarding tables 216A-B at respective virtual switches 215A-B. Forwarding tables 216A-B may each include entries that collectively implement the respective logical switches. Further, logical DRs that provide logical layer-3 connectivity may be implemented collectively by DR instances 217A-B and represented internally using routing tables (not shown) at respective DR instances 217A-B. Each routing table may include entries that collectively implement the respective logical DRs.

Packets may be received from, or sent to, each VM via an associated logical port (not shown for simplicity). Here, the term “logical port” or “logical switch port” may refer generally to a port on a logical switch to which a virtualized computing instance is connected. A “logical switch” mayrefer generally to a software-defined networking

(SDN) construct that is collectively implemented by virtual switches 215A-B, whereas a “virtual switch” mayrefer generally to a software switch or software implementation of a physical switch. In practice, there is usually a one-to-one mapping between a logical port on a logical switch and a virtual port on virtual switch 215A/215B. However, the mapping may change in some scenarios, such as when the logical port is mapped to a different virtual port on a different virtual switch after migration of the corresponding virtualized computing instance (e.g., when the source host and destination host do not have a distributed virtual switch spanning them).

A logical overlay network may be formed using any suitable tunneling protocol, such as Virtual eXtensible Local Area Network (VXLAN), Stateless Transport Tunneling (STT), Generic Network Virtualization Encapsulation (GENEVE), Generic Routing Encapsulation (GRE), etc. For example, VXLAN is a layer-2 overlay scheme on a layer-3 network that uses tunnel encapsulation to extend layer-2 segments across multiple hosts which may reside on different layer 2 physical networks. Hypervisor 214A/214B may implement virtual tunnel endpoint (VTEP) 219A/219B to encapsulate and decapsulate packets with an outer header (also known as a tunnel header) identifying the relevant logical overlay network (e.g., VNI). Hosts 210A-B may maintain data-plane connectivity with each other via physical network 205 to facilitate east-west communication among VMs 231-234.

### Data Center Security

One of the challenges in SDN environment 100 is improving the overall data center security. For example, to protect against security threats caused by unwanted packets, hypervisor 214A/214B may implement distributed firewall (DFW) engine 218A/218B and/or intrusion detection and prevention system (IDPS) engine 219A/219B as security controls to filter packets to/from associated VMs 231-234. In practice, packets may be filtered at any point along a datapath from a source (e.g., VM1 231) to a physical NIC (e.g., 224A/224B) on host 210A/210B.

At host-A 210A, for example, hypervisor-A 214A implements DFW engine 218A and/or IDPS engine 219A to filter packets for VM1 231 and VM2 232. At host-B 210B, hypervisor-B 214B implements DFW engine 218B and/or IDPS engine 219B to filter packets for VM3 233 and VM4 234. DFW engine 218A/218B may filter packets based on any suitable security policies in the form of firewall rules. Additionally or alternatively, IDPS engine 219A/219B may be configured to filter packets according to any suitable security policies in the form of IDPS rules.

In practice, however, malicious actors typically employ a multitude of tactics and techniques to breach an organization's defenses. In more recent times, it is observed that security attacks increasingly rely on lateral movements within SDN environment 100. Here, attackers may pivot laterally between workloads and beyond their initial point of attack (i.e., patient zero) in order to gain access to valuable resources or to cause the greatest amount of damage. This highlights the importance of east-west security controls beyond the perimeter (i.e., north-south) of the data center.

Given the complexity of security attacks and the distributed nature of modern applications, it may be challenging to design and implement security policies to safeguard various entities in SDN environment 100.

### Security Threat Analysis

According to examples of the present disclosure, security threat analysis may be implemented to improve data center security. Using examples of the present disclosure, test packets having malicious content may be forwarded from one network element to another to test the efficacy or effectiveness of various security policies (e.g.,

DFW and/or IDPS rules). As used herein, the term “malicious content” mayrefer generally to header and/or payload information in a packet that is associated with a security threat. The term “security threat” maybe used as an umbrella term to cover hostile or intrusive software, including but not limited to exploit codes, botnets, viruses, worms, Trojan horse programs, spyware, phishing, adware, riskware, rootkits, spams, scareware, ransomware, or any combination thereof. A test packet with “malicious content” maybe an unwanted packet that, for example, attempts to reach a particular destination to launch a security attack.

Examples of the present disclosure may be implemented as part of a breach and attack simulation (BAS) or distributed BAS (DBAS) solution to test the effectiveness of various security policies against substantially realistic and complicated security attacks. In general, BAS solutions are designed to test security performance by simulating an attack scenario and provide an analysis of how security controls perform. According to Gartner® Research, BAS technologies are defined as tools “that allow enterprises to continually and consistently simulate a full attack cycle (including insider threats, lateral movement and data exfiltration) against enterprise infrastructure, using software agents, virtual machines and other means.”

Examples of the present disclosure may be implemented to provide a substantially easy-to-use simulation capability without necessitating the deployment of additional proprietary agents that are required by conventional BAS solutions. Such agent-based approaches often come with several challenges. First, users may object to deploying agents on production workloads because it may require orchestration, cause additional overhead and require compliance sign-off, possibly delaying the roll-out of an effective BAS. Second, when agents are deployed, there is a non-zero risk that malicious packets may be delivered to, and adversely impact on, those production workloads. In some cases, compliance policies at various enterprises may not allow such conventional BAS solutions.

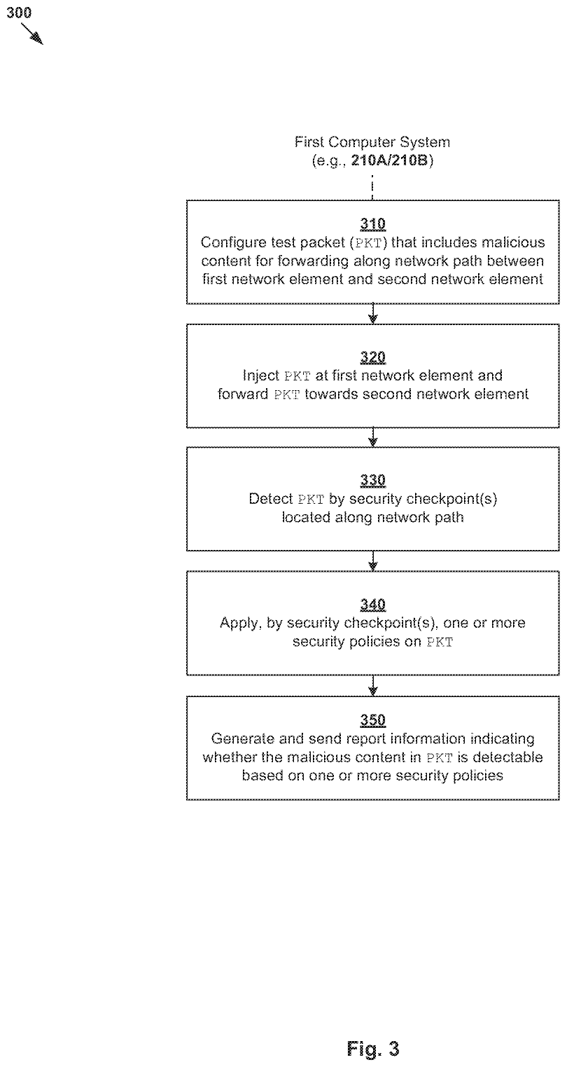

Some examples will be described using FIG. 3, which is a flowchart of example process 300 for a first computer system to perform security threat analysis in

SDN environment 100. Example process 300 may include one or more operations, functions, or actions illustrated by one or more blocks, such as 310 to 350. Depending on the desired implementation, various blocks may be combined into fewer blocks, divided into additional blocks, and/or eliminated.

In the following, various examples will be discussed using host 210A/210B as an example “computer system,” VM 231/233 as example “virtualized computing instance” and VNIC 261/263 as example “network element.” In practice, host 210A/210B may implement examples of the present disclosure using any suitable hardware and/or software. For example, host 210A/210B may include security threat analyzer 270A/270B (or security threat analysis module) may be configured to perform blocks 310-320. Host 210A/210B may further include security checkpoint(s) to perform blocks 330-350, such as DFW engine 218A/218B, IDPS engine 219A/219B, etc.

At 310 in FIG. 3, host-A 210A (e.g., using security threat analyzer 270A) may configure a test packet that includes malicious content for forwarding along a network path between (a) first network element=VNIC1 261 associated with VM1 231 supported by host-A 210A and (b) second network element=VNIC3 263 associated with VM3 233 supported by host-B 210B. At 320, host-A 210A (e.g., using security threat analyzer 270A) may inject the test packet at first network element=VNIC1 261 and forward the test packet towards second network element=VNIC3 263.

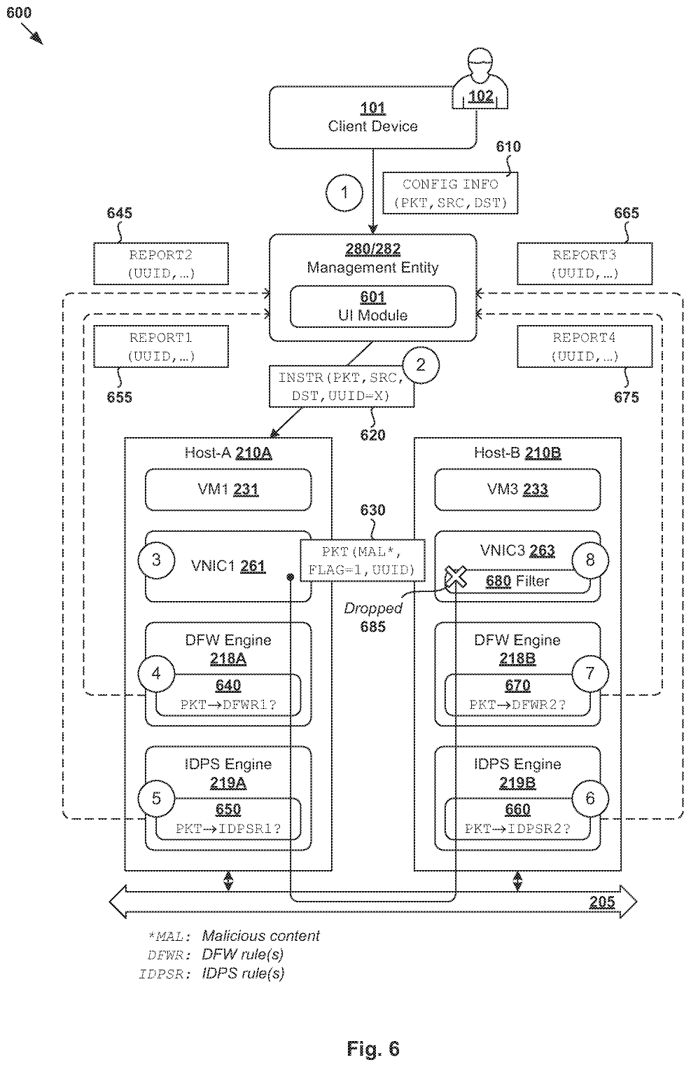

Using the example in FIG. 1, test packet 110 (denoted as “PKT”) may include malicious content (denoted as “MAL”) associated with any suitable security threat. Depending on the desired implementation, test packet 110 may be configured based on a packet capture (PCAP) file that is (a) uploaded by user 102 using client device 101, or (b) selected by user 102 from a library of multiple PCAP files associated with respective multiple security threats. This way, a previously captured packet may be configured for replay over the network. Second network element=VNIC3 263 may be configured to apply a filter (e.g., see 680 in FIG. 6) to intercept and drop test packet 110 before test packet 110 reaches VM3 233.

At 330-340 in FIG. 3, in response to detecting test packet 110 by a security checkpoint that is located along the network path and supported by host-A 210A, the security checkpoint may apply one or more security policies on test packet 110. Further, at 350 in FIG. 3, the security checkpoint may generate and send report information towards management entity 280/282. Here, the report information may indicate whether the malicious content in the test packet is detectable based on the one or more security policies.

As used herein, the term “security checkpoint” mayrefer generally to any suitable component that is capable of applying one or more security policies on test packets that are being forwarded along a network path. In the example in FIG. 1, DFW engine 218A/218B may be configured to be a “security checkpoint” to apply security policies in the form of firewall rules. Additionally or alternatively, IDPS engine 219A/219B may be configured to be a “security checkpoint” to apply security policies in the form of IDPS rules. Any additional and/or alternative security checkpoints may be configured along the pathway of communication of a simulated attack, such as malware detection and/or prevention engine, network traffic analysis (NTA) module, etc.

Depending on the desired implementation, security threat analysis may be applied to VNIC 261/262/263/264 of VM 231/232/233/234. This way, a security attack may be simulated between multiple workloads in a distributed manner regardless of their physical placement on physical host(s). Although first virtualized computing instance=VM1 231 on host-A 210A and second virtualized computing instance=VM3 233 on host-B 210B are used as examples in FIGS. 1 and 5-7, it should be understood that both virtualized computing instances may be supported by the same host. For example (see 290 in FIG. 2), a second test packet with malicious content may be configured and injected at (a) VNIC2 262 associated with VM2 232 for traversal towards (b) VNIC1 261 associated with VM1 231 on the same host-A 210A. In another example (see 292 in FIG. 2), a third test packet may be configured and injected at (a) VNIC4 264 associated with VM4 234 for traversal towards (b) VNIC3 263 associated with VM3 233 on the same host-B 210B. Various examples will be discussed using FIGS. 1-7 below.

### Example User Interface

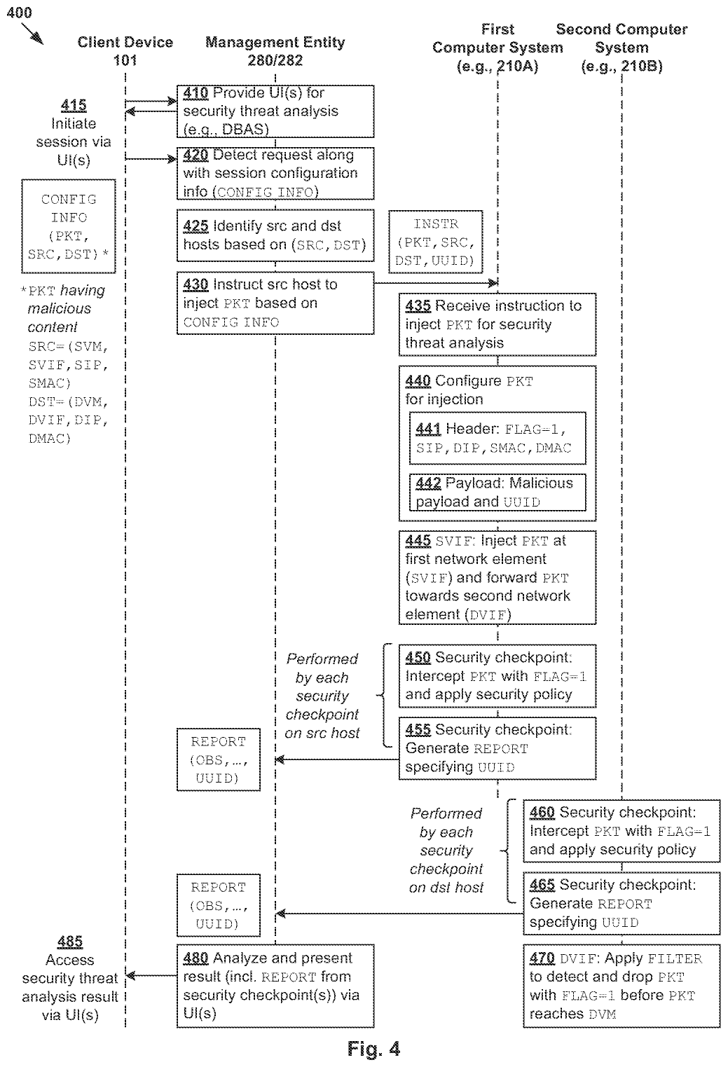

FIG. 4 is a flowchart of example detailed process 400 for a first computer system to perform security threat analysis in an SDN environment. Example process 400 may include one or more operations, functions, or actions illustrated by one or more blocks, such as 410 to 485. Depending on the desired implementation, various blocks may be combined into fewer blocks, divided into additional blocks, and/or eliminated. Using host-A 210A as an example, blocks 435-445 in FIG. 4 maybe performed by security threat analyzer 270A, and blocks 450-455 by DFW engine 218A and/or IDPS engine 219A.

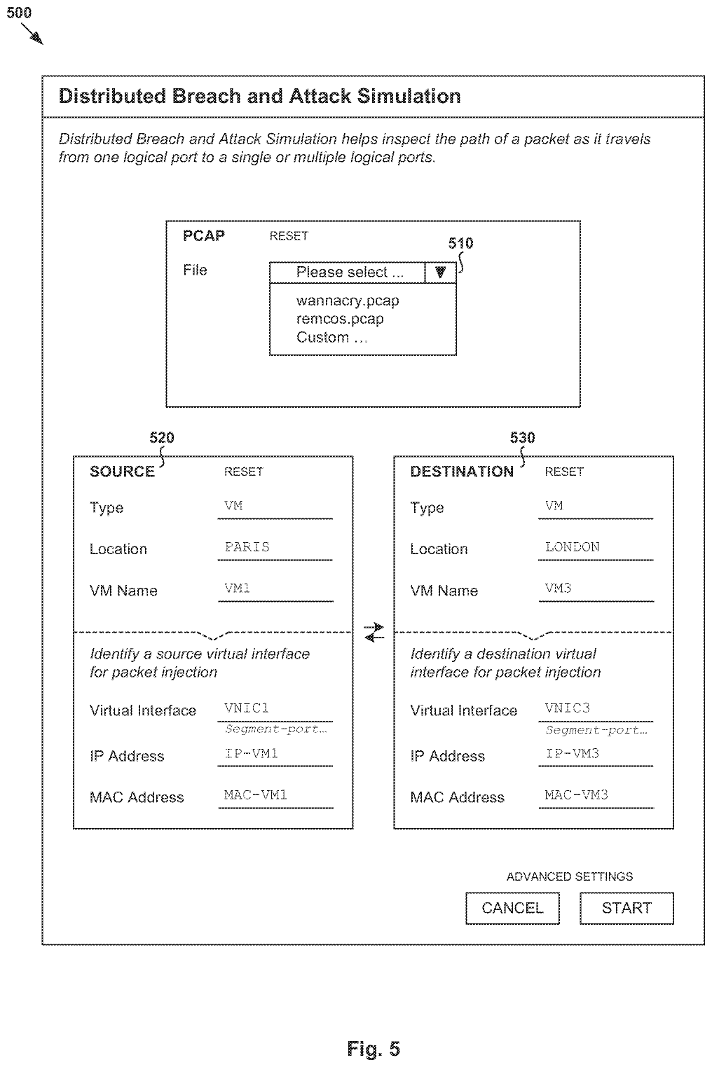

First, blocks 410-420 in FIG. 4 will be explained using FIG. 5, which is a schematic diagram illustrating example user interface 500 for initiating a security threat analysis in SDN environment. The following notations will be used: SIP=source IP address, DIP=destination IP address, SMAC=source MAC address, DMAC=destination MAC, SPN=source port number, DPN=destination port number, SVIF=source virtual interface, DVIF=destination virtual interface, SVM=source VM and DVM=destination VM.

At 410-415 in FIG. 4, user 102 operating client device 101 may initiate a session of security threat analysis by generating and sending configuration information to management entity 280/282. The security threat analysis may be initiated by interacting with any suitable user interface (UI) provided by management entity 280/282. Example UI(s) may include graphical user interface (GUI), application programming interface (API), command line interface (CLI), etc. A GUI may include any suitable UI elements, such as checkbox(es), button(s), window(s), tab(s), list(s), dropdown list(s), any combination thereof, etc.

In FIG. 5, example UI 500 may be presented to user 102 to facilitate input of the configuration information, including a test packet to be injected (see 510), source and destination information (see 520-530). In one example, the test packet may be configured based on a packet capture (PCAP) file that is uploaded by user 102. Alternatively or additionally, the test packet may be selected from a library of PCAP files accessible via example UI 500. The library may include built-in PCAP files associated with various security threats, thereby allowing user 102 to quickly select a PCAP file to test their security controls against a particular security threat. The library may be shipped along with a software update, and thereafter updated periodically from a cloud service.

In general, the content of a packet may be saved into a PCAP file using any suitable approach, such as a packet capture utility, etc. In the example in FIG. 5, “wannacry.pcap” and “remcos.pcap” (see 510) are shown as example PCAP files associated with various security attacks. In this example, the “wannacry.pcap” file may be selected to test the effectiveness of security policies against the WannaCry malware, which is used for ransomware attack in order for malicious actors to extort money. The “remcos.pcap” file may be selected to test the effectiveness of security policies against the Remote Control and Surveillance Software (Remcos) malware, which is a remote access trojan that is used to fully control and monitor computers. Example UI 500 may provide any additional and/or alternative PCAP file(s) for selection.

Further, example UI 500 in FIG. 5 maybe presented to user 102 to provide source information 520 may include source type=virtual machine, location=Paris, source VM name=VM1 231, source virtual interface=VNIC1 261, source IP address=IP-VM1 and source MAC address=MAC-VM1. Destination information 530 may include destination type=virtual machine, geographical location=Paris, destination VM name=VM3 233, destination virtual interface=VNIC3 263, destination IP address=IP-VM3 and destination MAC address=MAC-VM3.

### Example Security Threat Analysis

Blocks 420-470 in FIG. 4 will be explained using FIG. 6, which is a schematic diagram illustrating detailed example 600 of security threat analysis in SDN environment 100. In the example in FIG. 6, examples of the present disclosure may be implemented to facilitate a distributed BAS between VM1 231 and VM3 233. It should be understood that test packet(s) may be configured and injected for forwarding from a single “first network element” (e.g., source VNIC) to multiple “second network elements” (e.g., destination VNICs).

(a) Test packet injection

At 420-425 in FIG. 4, in response to receiving a request from client device 101, management entity 280/282 may identify the source and destination hosts for security threat analysis. In the example in FIG. 6, source host=host 210A supporting source VM1 231 and destination host=210B supporting destination VM3 233 may be identified based on configuration information (see 610) from client device 101.

At 430-435 in FIG. 4, source host-A 210A may receive control information (see 620 in FIG. 6) from management entity 280/282 to perform test packet injection based on configuration information from client device 101. Control information 620 may further specify a universally unique identifier (UUID) to be appended to the test packet. The UUID (e.g., X) may be used as a unique session ID for the security threat analysis (to be explained further using blocks 440, 455 and 465 in FIG. 4).

At 440 in FIG. 4, source host-A 210A may configure header and/or payload information of a test packet for security threat analysis. At 441 in FIG. 4, the test packet may be configured to specify source address information (SIP=IP-VM1, SMAC=MAC-VM1) associated with VM1 231 and destination address information (DIP=IP-VM3, DMAC=MAC-VM3) associated with VM3 233. Block 441 may also include configuring the header information (e.g., outer GENEVE header) of the test packet to include a meta-flag denoted as FLAG=1 to distinguish the packet from regular packets. FLAG=1 is also to cause security checkpoint(s) to generate and send report information. Further, at 442 in FIG. 4, payload information of the test packet may be appended with UUID=X to the to facilitate generation of report information that includes the UUID.

Depending on the desired implementation, configuration steps 441-442 may be performed by host-A 210A and/or management entity 280/282. In one approach, block 440 may involve host-A 210A receiving a test packet from management entity 280/282, which configures the test packet to specify (SIP=IP-VM1, SMAC=MAC-VM1, DIP=IP-VM3, DMAC=MAC-VM3, UUID=X). In response, host-A 210A may configure an outer header of the test packet to specify FLAG=1 prior to test packet injection. Alternatively, block 440 may involve host-A 210A configuring the header and/or payload information of the test packet to specify (SIP=IP-VM1, SMAC=MAC-VM1, DIP=IP-VM3, DMAC=MAC-VM3, UUID=X, FLAG=1) based on control information 620 from management entity 280/282.

At 445 in FIG. 4, source host 210A may inject the test packet at source virtual interface=VNIC1 261 (“first network element”) that is connected with source VM1 231 and forward the test packet towards destination virtual interface=VNIC3 263 (“second network element”) that is connected with destination VM3 233 on host-B 210B. See example test packet 630 in FIG. 6 with malicious content (denoted as MAL), FLAG=1 and UUID appended to its payload.

(b) Security checkpoints and policies

At 450 and 460 in FIG. 4, a security checkpoint located along a network path between VNIC1 261 and VNIC3 263 may intercept the test packet and apply one or more security policies. In the example in FIG. 6, first DFW engine 218A on host-A 210A and second DFW engine 218B on host-B 210B may be configured as security checkpoints to apply security policies in the form of firewall rules. In general, a firewall rule may be configured to specify (a) match field(s) specifying tuple information to be matched with a packet, and (b) an action to be performed if there is a match. This way, packets may be filtered based on tuple information, such as SIP, DIP, SMAC, DMAC, SPN, DPN, protocol, or any combination thereof.

Alternatively or additionally, first IDPS engine 219A on host-A 210A and second IDPS engine 219B on host-B 210B may be configured as security checkpoints to apply security policies in the form of IDPS rules. Using signature-based IDPS, for example, a particular IDPS rule may specify (a) match field(s) specifying tuple information to be matched with a packet, (b) at least one signature to be matched with the test packet and (c) an action to be performed in case of a match.

Similarly, the tuple information may include SIP, DIP, SMAC, DMAC, SPN, DPN, protocol, or any combination thereof. In practice, a set of signature(s) may be defined as part of a security profile associated with the IDPS rule. A signature may be defined or expressed using a signature rule specifying one or more patterns. Each pattern may be expressed using any suitable string that is detectable from a packet that includes malicious content, such as a sequence of byte(s) and/or text character(s), etc.

For each firewall or IDPS rule, any suitable action may be defined, such as “detect only” (i.e., an alert will be raised, but the test packet is allowed to go through when malicious content is detected), “detect and prevent” (i.e., drop/block the test packet when malicious content is detected), etc. In other words, when action=“detect and prevent” is performed, the test packet may be dropped/blocked and it is not necessary to continue forwarding the test packet towards VNIC3 263.

(c) Report information

At 455 and 465 in FIG. 4, the security checkpoint may generate and send report information that indicates whether the malicious content in the test packet is detectable based on the one or more security policies. Some examples will be explained using FIG. 6. In the following, consider a scenario where security policies with action=“detect” are applied, and test packet 630 is forwarded from VNIC1 261 to

VNIC3 263 via the security checkpoints below.

In a first example, in response to detecting test packet 630 having FLAG=1, DFW engine 218A on source host-A 210A may apply a first set of firewall rule(s) denoted as DFWR1. Next, DFW engine 218A may generate and send, to management entity 280/282, first report information (“REPORT1”) indicating whether the malicious content in test packet 630 is detectable based on the firewall rule(s). REPORT1 includes the UUID extracted from test packet 630. See 640-645 in FIG. 6.

In a second example, in response to detecting test packet 630 having FLAG=1, IDPS engine 219A may apply a first set of IDPS rule(s) denoted as IDPSR1. Next,

IDPS engine 219A may generate and send, to management entity 280/282, second report information (“REPORT2”) indicating whether the malicious content in test packet 630 is detectable based on the IDPS rule(s). REPORT2 includes the UUID extracted from test packet 630. See 650-655 in FIG. 6.

In a third example, in response to detecting test packet 630 having FLAG=1, IDPS engine 219B may apply a second set of IDPS rule(s) denoted as IDPSR2. Next, IDPS engine 219B may generate and send, to management entity 280/282, third report information (“REPORT3”) indicating whether the malicious content in test packet 630 is detectable based on the IDPS rule(s). REPORT3 includes the UUID extracted from test packet 630. See 660-665 in FIG. 6.

Depending on the desired implementation, a dvfilter channel may be used once a packet is matched to an IDPS rule within a kernel space and the packet needs to be punted to a user space. Once punted from the kernel space to the user space via the dvfilter channel, IPDS engine 219A/219B may process the packet to identify any malicious content in the packet.

In a fourth example, in response to detecting test packet 630 having FLAG=1, DFW engine 218B on source host-B 210B may apply a second set of firewall rule(s) denoted as DFWR2. Next, DFW engine 218B may generate and send, to management entity 280/282, fourth report information (“REPORT4”) indicating whether the malicious content in test packet 630 is detectable based on the firewall rule(s). REPORT4 includes the UUID extracted from test packet 630. See 670-675 in FIG. 6.

(d) Test packet removal

At 470 in FIG. 4, VNIC3 263 on destination host-B 210B may apply a filter to detect and drop test packet 630. In the example in FIG. 6, VNIC3 263 may implement filter 680, which may be an agent (known as a dvfilter) that is configured to intercept packets to protect VM3 233 from security attacks and unwanted traffic. Filter 680 may specify source address information=(IP-VM1, MAC-VM1) and destination address information=(IP-VM3, MAC-VM3) to be matched to test packet 630. This way, test packet 630 may be dropped by VNIC3 263 and not delivered to VM3 233. This is to reduce the likelihood of, if not prevent, adverse effect on VM3 233. See 685 in FIG. 6.

### Example Report Information

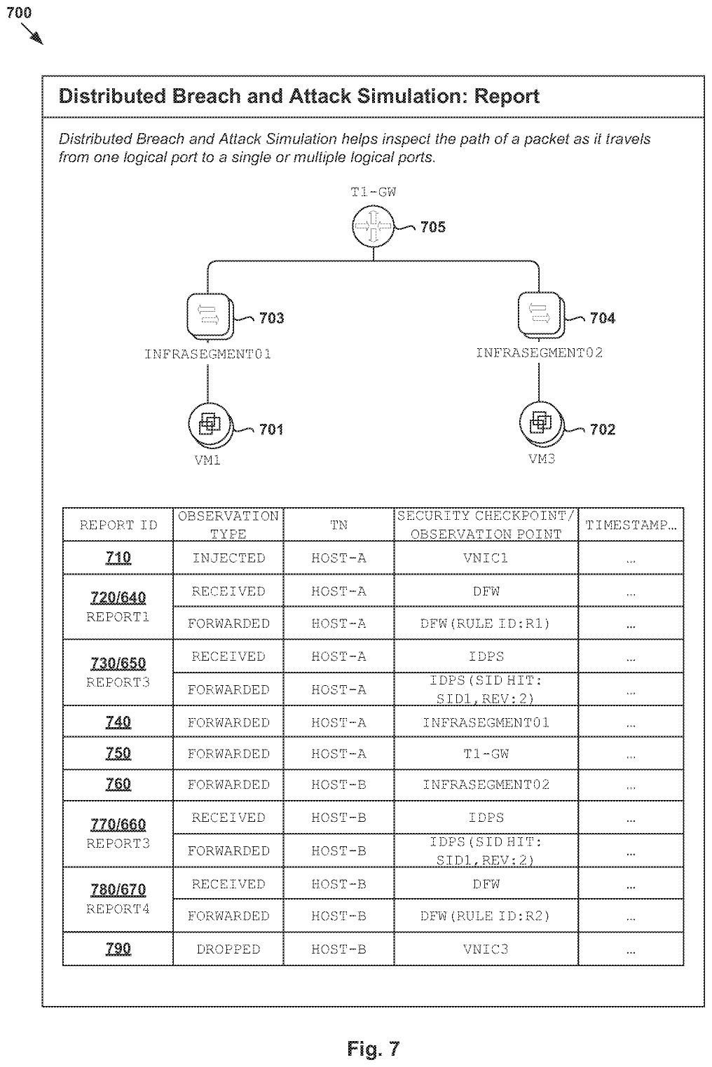

FIG. 7 is a schematic diagram illustrating example user interface 700 for presenting report information associated with security threat analysis in SDN environment 100. Here, example UI 700 may display a network diagram showing how source VM=VM1 231 (see 701) is connected to destination VM=VM3 233 (see 702) via logical network elements 703-705. For example, VM1 231 and VM3 233 are connected via logical switches or segments (see INFRASEGMENT01 703 and

INFRASEGMENT02 704), which are in turn connected via a logical router in the form of a tier 1 gateway (see T1-GW 705).

Logical network elements 703-705, along with VNIC1 261 and VNIC3 263, may be configured as observation points to generate and send additional report information associated with test packet 630 to management entity 280/282. For example, source VNIC1 261 may report that test packet 630 has been injected. Intermediate observation points (e.g., 703-705) may report that test packet 630 has been forwarded. Destination VNIC 263 may report that test packet has been dropped, thereby preventing it from reaching VM3 233. See 710, 740-760 and 790.

Example UI 700 may also include UI elements to present report information generated by various security checkpoints. Note that example UI 700 in FIG. 7 may include report information from other observation points, such as VNIC 261/263, logical switches 703-704, logical router 705 and logical ports (not shown). At source host-A 210A, REPORT1 640 (see also 720) from DFW engine 218A in FIG. 6 mayindicate that test packet 630 has been received and forwarded, and its malicious content detected using a firewall rule associated with ID=R1. Similarly, REPORT2 650 (see also 730) from IDPS engine 219A may indicate that test packet 630 has been received and forwarded, and its malicious content detected. Here, a signature hit event is detected by applying an IDPS rule associated with signature ID=SID1.

Further, REPORT3 660 (see also 770) from IDPS engine 219B on host-B 210B may indicate that test packet 630 has been received and forwarded, and its malicious content detected. Here, a signature hit event is detected by applying an IDPS rule associated with signature ID=SID1. REPORT4 670 (see also 780) from DFW engine 218B indicates that test packet 630 has been received and forwarded, and its malicious content detected using a firewall rule associated with ID=R2.

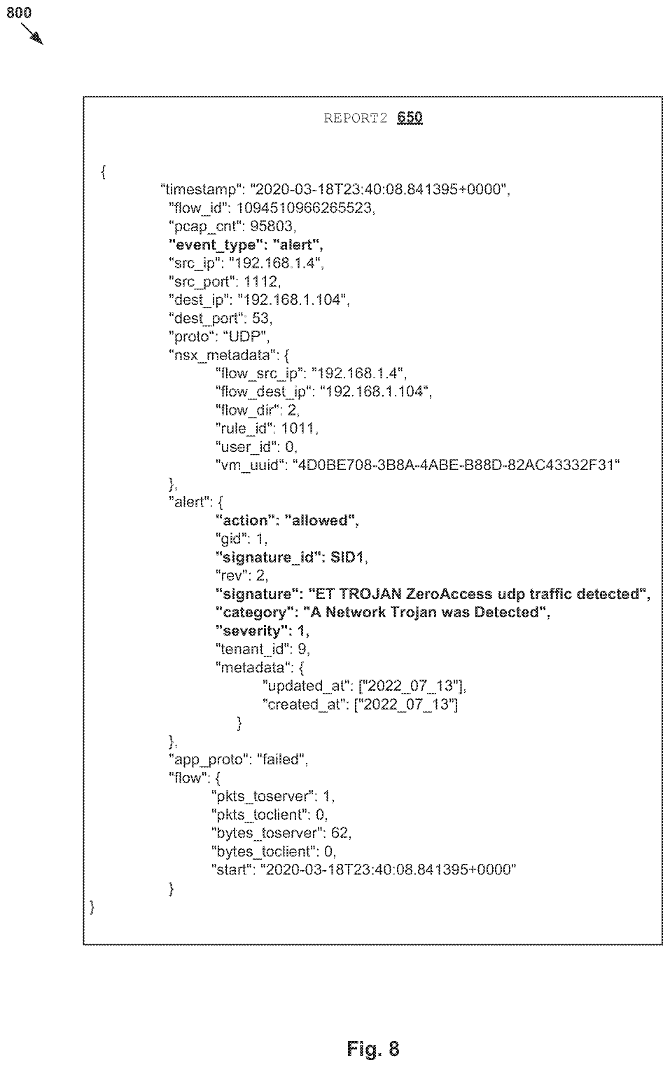

Report information 640-670 may include any suitable details. For example, FIG. 8 is a diagram illustrating detailed example report information 800 associated with an IDPS event during security threat analysis. In this example, report information 800 (i.e., REPORT2 650 in FIGS. 6-7) may provide a description of the IDPS event, including tuple information of test packet 630 and characteristics of a signature matched to test packet 830. The latter may include signature ID, revision number, category=“A network trojan was detected,” severity level, etc. Based on report information in FIGS. 7-8, user 102 may assess the effectiveness of security controls implemented by various security checkpoints. For example, if the malicious content in test packet 630 is not detectable, security policies may be improved to strengthen data center security. One possible outcome would be for users/customers to accept or assume the risk of security threat(s) or implement mitigating controls.

When used as a pre-sales tool, examples of the present disclosure may facilitate a non-disruptive test of existing security controls as well as native security features in SDN environment 100. Report information associated with security threat analysis may assist user(s) 102 to design and implement security policies that achieve better segmentation and threat prevention. Beyond pre-sales, examples of the present disclosure may be implemented to provide a tool for customers to continuously validate the efficacy of their security controls throughout their virtualized data center.

### DBAS For End-to-End Attack Scenario

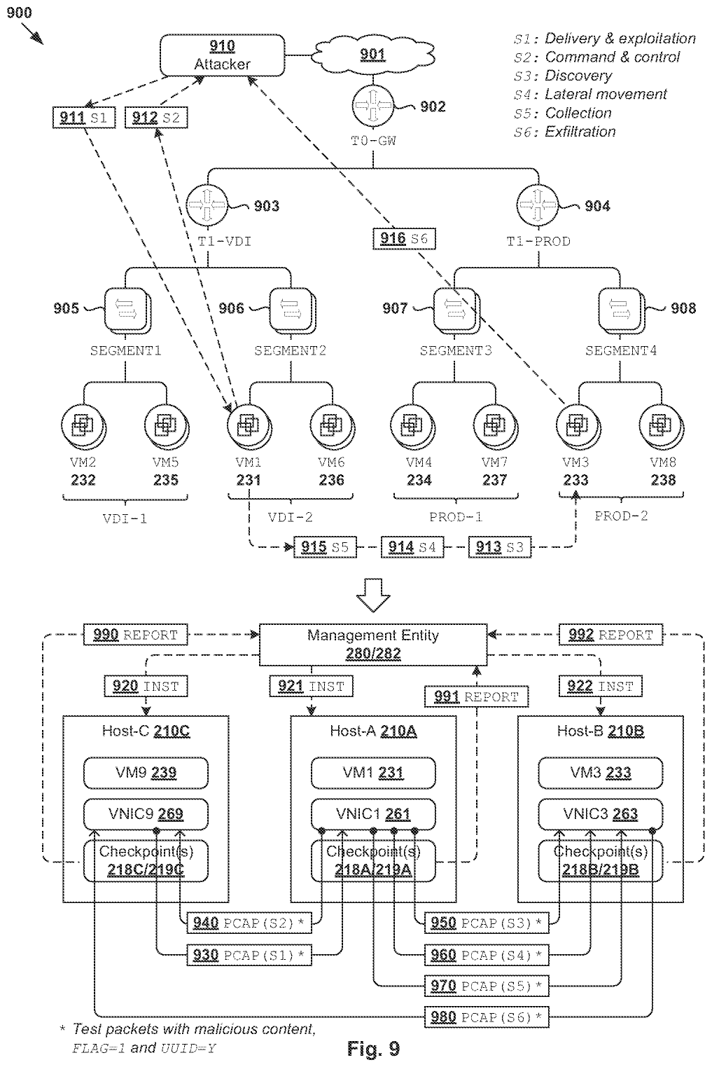

Examples of the present disclosure may be implemented to simulate sophisticated full-cycle security attacks. In this case, the example test packet configuration and injection in FIGS. 4-8 maybe performed to simulate one of multiple stages of a security attack. One example is shown in FIG. 9, which is a schematic diagram illustrating example security threat analysis 900 for an end-to-end attack scenario in SDN environment 100.

In the example in FIG. 9, VMs 231-238 may be connected via to external network 901 via tier-0 gateway 902 (see T0-GW), tier-1 logical routers 903-904 (see T1-VDI and T1-PROD) and logical segments 905-908 (see SEGMENT1 to SEGMENT4). VM1 231, VM2 232, VM5 235 and VM6 236 may be VMs that are configured to support remote access to virtual desktops using virtual desktop infrastructure (VDI) technology. Remaining VM3 233, VM4 234, VM7 237 and VM8 238 may be VMs deployed in production environments.

(a) Multiple stages of a security attack

In practice, attacker 910 (i.e., malicious entity) in FIG. 9 maylaunch a full security attack from an external network. The security attack may involve multiple stages, such as S1 to S6 (see 911-916). For example, at S1 911 (delivery and exploitation stage), attacker 910 may deliver malicious payload to primary target=VM1 231 and exploit vulnerable application(s) running on the target to gain an initial entry into an organization. At S2 912 (command and control stage), attacker 910 may interact with infected VM1 231 once malware is installed. The purpose is to establish a command channel for attacker 910 to instruct VM1 231 to execute the next stages of the security attack.

At S3 913 (discovery stage), VM1 231 may be instructed by attacker 910 to discover vulnerabilities in other VMs, such as using horizontal and/or vertical port scanning, etc. For example, primary target=VM1 231 may initiate a vertical port scan by sending requests to different ports on secondary target=VM3 233 to look for system flaws. At S4 914 (lateral movement stage), VM1 231 may be instructed to initiate a remote desktop protocol (RDP) session with VM3 233. At S5 915 (i.e., collection stage), VM1 231 may be instructed to access an organization's confidential data (e.g., customer account data) using the RDP session with VM3 233.

At S6 916 (data exfiltration stage), an unauthorized transfer may be initiated such that attacker 910 is able to gain access to the confidential data. In practice, data exfiltration is difficult to detect because it involves data transfer that resembles typical network traffic. Unfortunately, once the confidential data is in the hand of attacker 910, the damages may be significant.

(b) Security threat analysis

To strengthen data center security, examples of the present disclosure may be implemented to simulate multiple security attack stages and test the effectiveness of various security controls against each and every stage. In the example in FIG. 9, packets associated with stages 911-916 may be captured and stored in PCAP files. To simulate a multi-stage security attack, these packets may then be “replayed” in SDN environment 100 to determine whether security policies are able to detect them. In the following, VM9 239 on host-C 210C may be configured to represent or simulate a system associated with attacker 910. Note that host-C 210C may include similar components to hosts 210A-B, including DFW engine 218C and IDPS engine 219C.

At 920-922 in FIG. 9, hosts 210A-C may receive control information from management entity 280/282 instructing them to perform test packet configuration and injection as part of a session of security threat analysis associated with a multi-stage security attack. For reporting purposes, the particular session may be associated with UUID=Y.

At 930 in FIG. 9, in response to receiving control information 920, host-C 210C may configure and inject a first test packet denoted as “PCAP(S1)” at source VNIC9 269 to simulate stage=S1 911 (delivery and exploitation). Test packet 930 may be configured based on a packet captured during S1 911 to include source address information=(IP-VM9, MAC-VM9), destination address information=(IP-VM1, MAC-VM1), FLAG=1 and UUID=Y. Test packet 930 is then forwarded from source VNIC9 269 to destination VNIC1 261 where it is removed without reaching VM1 231. In response to detecting test packet 930, DFW engine 218A/218C and/or IDPS engine 219A/219C may apply security policies, as well as generate and send report information 990/991 to management entity 280/282.

At 940 in FIG. 9, in response to receiving control information 921, host-A 210A may configure and inject a second test packet denoted as “PCAP(S2)” at source VNIC1 261 to simulate stage=S2 912 (delivery and exploitation). The test packet may be configured based on a packet captured during S2 912 to include source address information=(IP-VM1, MAC-VM1), destination address information=(IP-VM9, MAC-VM9), FLAG=1 and UUID=Y. The test packet is then forwarded from source VNIC1 261 to destination VNIC9 269. In response to detecting test packet 930, DFW engine 218A/218C and/or IDPS engine 219A/219C may apply security policies, as well as generate and send report information 990/991 to management entity 280/282.

The above may be repeated for subsequent stages. At 950-970 in FIG. 9, host-A 210A may configure and inject test packets denoted as “PCAP(S3),” “PCAP(S4)” and “PCAP(S5)” to simulate respective stages S3 950, S4 960 and S5 970. Test packets 950-970 may be injected at source VNIC1 261 for forwarding towards destination VNIC3 263 where they are removed without reaching VM3 233. In response to detecting test packet 950-970, DFW engine 218A/218B and/or IDPS engine 219A/219B may apply security policies, as well as generate and send report information 991/992 to management entity 280/282.

At 980 in FIG. 9, in response to receiving control information 922, host-B 210B may inject a test packet denoted as “PCAP(S6)” at source VNIC3 263 to simulate final stage=S6 916. The test packet may be configured based on a packet captured during S6 916 to include source address information=(IP-VM3, MAC-VM3), destination address information=(IP-VM9, MAC-VM9), FLAG=1 and UUID=Y. The test packet is then forwarded from source VNIC3 263 to destination VNIC9 269. In response to detecting test packet 980, DFW engine 218B/218C and/or IDPS engine 219B/219C may apply security policies, as well as generate and send report information 990/992 to management entity 280/282.

Based on report information 990-992, users (e.g., network administrators) may assess whether security policies implemented by various security checkpoints are able to defend against the simulated multi-stage attack. In practice, users may be able to initiate scenario-based testing on-demand on a scheduled basis. Upon completing a scenario, management entity 280/282 may collect and present configuration and report information associated with the test. The report information may indicate whether each stage of the simulated attack is successful or not (i.e., desired outcome) along with the security policy or policies applied. In cases where these security policies are determined to be inadequate, improvements may be made to better safeguard various VMs against similar attacks in the future.

### Container Implementation

Although discussed using VMs 231-238, it should be understood that security threat analysis may be performed for other virtualized computing instances, such as containers, etc. The term “container” (also known as “container instance”) is used generally to describe an application that is encapsulated with all its dependencies (e.g., binaries, libraries, etc.). For example, multiple containers may be executed as isolated processes inside VM1 231, where a different VNIC is configured for each container. Each container is “OS-less”, meaning that it does not include any OS that could weigh 10 s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies.

### Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 9. For example, a computer system capable of acting as host 210A/210B may be deployed in SDN environment 100 to perform examples of the present disclosure.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples.

Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described or can be alternatively located in one or more devices different from that in the examples. The units in the examples described can be combined into one module or further divided into a plurality of sub-units.

1. A method for a first computer system to perform security threat analysis, wherein the method comprises:
configuring a test packet that includes malicious content for forwarding along a network path between (a) a first network element that is connected with a first virtualized computing instance supported by the first computer system, and (b) a second network element that is connected with a second virtualized computing instance supported by the first computer system or a second computer system;
injecting the test packet at the first network element and forwarding the test packet towards the second network element; and
in response to detecting the test packet by a security checkpoint that is located along the network path and supported by the first computer system,
applying, by the security checkpoint, one or more security policies on the test packet; and
generating and sending, by the security checkpoint, report information towards a management entity, wherein the report information indicates whether the malicious content in the test packet is detectable based on the one or more security policies.

2. The method of claim 1, wherein injecting the test packet comprises:
forwarding the test packet towards the second network element that is configured to apply a filter to intercept and drop the test packet before the test packet reaches the second virtualized computing instance.

3. The method of claim 1, wherein configuring the packet comprises:
configuring the packet to include a flag and a universally unique identifier (UUID) to cause the security checkpoint to generate and send the report information that specifies the UUID.

4. The method of claim 1, wherein applying the one or more security policies comprises:
applying, by the security checkpoint in the form of an intrusion detection and prevention system (IDPS) engine, one or more security policies in the form of IDPS rules, wherein each IDPS rule specifies (a) tuple information to be matched with the test packet, (b) at least one signature to be matched with the test packet and (c) an action to be performed in case of a match.

5. The method of claim 1, wherein applying the one or more security policies comprises:
applying, by the security checkpoint in the form of a distributed firewall (DFW) engine, one or more security policies in the form of DFW rules, wherein each DFW rule specifies (a) tuple information to be matched with the test packet, and (b) an action to be performed in case of a match.

6. The method of claim 1, wherein configuring the test packet comprises:
configuring the test packet based on a packet capture (PCAP) file that is (a) uploaded by a user using a client device, or (b) selected by the user from a library of multiple PCAP files associated with respective multiple security threats.

7. The method of claim 1, wherein configuring and injecting the test packet comprises:
based on control information from a management entity, configuring and injecting the test packet to simulate one of multiple stages of a security attack, wherein the test packet is one of multiple test packets associated with the respective multiple stages.

8. A non-transitory computer-readable storage medium that includes a set of instructions which, in response to execution by a processor of a computer system, cause the processor to perform security threat analysis, wherein the method comprises:
configuring a test packet that includes malicious content for forwarding along a network path between (a) a first network element that is connected with a first virtualized computing instance supported by the first computer system, and (b) a second network element that is connected with a second virtualized computing instance supported by the first computer system or a second computer system;
injecting the test packet at the first network element and forwarding the test packet towards the second network element; and
in response to detecting the test packet by a security checkpoint that is located along the network path and supported by the first computer system,
applying, by the security checkpoint, one or more security policies on the test packet; and
generating and sending, by the security checkpoint, report information towards a management entity, wherein the report information indicates whether the malicious content in the test packet is detectable based on the one or more security policies.

9. The non-transitory computer-readable storage medium of claim 8, wherein injecting the test packet comprises:
forwarding the test packet towards the second network element that is configured to apply a filter to intercept and drop the test packet before the test packet reaches the second virtualized computing instance.

10. The non-transitory computer-readable storage medium of claim 8, wherein configuring the packet comprises:
configuring the packet to include a flag and a universally unique identifier (UUID) to cause the security checkpoint to generate and send the report information that specifies the UUID.

11. The non-transitory computer-readable storage medium of claim 8, wherein applying the one or more security policies comprises:
applying, by the security checkpoint in the form of an intrusion detection and prevention system (IDPS) engine, one or more security policies in the form of IDPS rules, wherein each IDPS rule specifies (a) tuple information to be matched with the test packet, (b) at least one signature to be matched with the test packet and (c) an action to be performed in case of a match.

12. The non-transitory computer-readable storage medium of claim 8, wherein applying the one or more security policies comprises:
applying, by the security checkpoint in the form of a distributed firewall (DFW) engine, one or more security policies in the form of DFW rules, wherein each DFW rule specifies (a) tuple information to be matched with the test packet, and (b) an action to be performed in case of a match.

13. The non-transitory computer-readable storage medium of claim 8, wherein configuring the test packet comprises:
configuring the test packet based on a packet capture (PCAP) file that is (a) uploaded by a user using a client device, or (b) selected by the user from a library of multiple PCAP files associated with respective multiple security threats.

14. The non-transitory computer-readable storage medium of claim 8, wherein configuring and injecting the test packet comprises:
based on control information from a management entity, configuring and injecting the test packet to simulate one of multiple stages of a security attack, wherein the test packet is one of multiple test packets associated with the respective multiple stages.

15. A computer system, being a first computer system, comprising:
a security threat analyzer; and
a security checkpoint, wherein:
the security threat analyzer is to configure a test packet that includes malicious content for forwarding along a network path between (a) a first network element that is connected with a first virtualized computing instance supported by the first computer system, and (b) a second network element that is connected with a second virtualized computing instance supported by the first computer system or a second computer system;
the security threat analyzer is further to inject the test packet at the first network element and forwarding the test packet towards the second network element; and
the security checkpoint is to, in response to detecting the test packet, (a) apply one or more security policies on the test packet; and (b) generate and send report information towards a management entity, wherein the report information indicates whether the malicious content in the test packet is detectable based on the one or more security policies.

16. The computer system of claim 15, wherein the security threat analyzer is to inject the test packet by performing the following:
forward the test packet towards the second network element that is configured to apply a filter to intercept and drop the test packet before the test packet reaches the second virtualized computing instance.

17. The computer system of claim 15, wherein the security threat analyzer is to configure the packet by performing the following:
configure the packet to include a flag and a universally unique identifier (UUID) to cause the security checkpoint to generate and send the report information that specifies the UUID.

18. The computer system of claim 15, wherein the security checkpoint is to apply the one or more security policies by performing the following:
apply, by the security checkpoint in the form of an intrusion detection and prevention system (IDPS) engine, one or more security policies in the form of IDPS rules, wherein each IDPS rule specifies (a) tuple information to be matched with the test packet, (b) at least one signature to be matched with the test packet and (c) an action to be performed in case of a match.

19. The computer system of claim 15, wherein the security checkpoint is to apply the one or more security policies by performing the following:
apply, by the security checkpoint in the form of a distributed firewall (DFW) engine, one or more security policies in the form of DFW rules, wherein each DFW rule specifies (a) tuple information to be matched with the test packet, and (b) an action to be performed in case of a match.

20. The computer system of claim 15, wherein the security threat analyzer is to configure the test packet by performing the following:
configure the test packet based on a packet capture (PCAP) file that is (a) uploaded by a user using a client device, or (b) selected by the user from a library of multiple PCAP files associated with respective multiple security threats.

21. The computer system of claim 15, wherein the security threat analyzer is to configure and inject the test packet by performing the following:
based on control information from a management entity, configure and inject the test packet to simulate one of multiple stages of a security attack, wherein the test packet is one of multiple test packets associated with the respective multiple stages.
